(19) United States
(12) Patent Application Publication
(10) Pub. No.: US 2015/0315404 A1
(43) Pub. Date: Nov. 5, 2015

(54) MULTI-FUNCTIONAL HIGH PERFORMANCE NANOCOATINGS FROM A FACILE CO-ASSEMBLY PROCESS

(71) Applicant: Texas State University, San Marcos, TX (US)

(72) Inventors: Luyi Sun, Pearland, TX (US); Fuchuan Ding, San Marcos, TX (US)

(21) Appl. No.: 14/682,560

(22) Filed: Apr. 9, 2015

Related U.S. Application Data
(63) Continuation-in-part of application No. PCT/US2013/065606, filed on Oct. 18, 2013.
(60) Provisional application No. 61/795,487, filed on Oct. 18, 2012.

(51) Int. Cl. C09D 129/04; B05D 3/12; B05D 1/18; B05D 3/06; C08K 3/32; C08K 3/34

(52) U.S. Cl. CPC C09D 129/04; C08K 3/32; C08K 3/34; B05D 1/18; B05D 3/06; B05D 3/12; C08K 2003/328

(57) ABSTRACT

Herein, is disclosed a nanocoating technology, which can provide excellent mechanical and barrier performance and flame retardancy, but meanwhile can be easily processed using currently widely adopted processing equipment. The process makes use of a nanocomposite coating composition that includes a nanomaterial, a binder, and a solvent.

### PRIORITY CLAIM

This application is a continuation-in-part of PCT Application PCT/US2013/065606, filed Oct. 18, 2013, which claims priority to U.S. Provisional Application Ser. No. 61/795,487 entitled “Nanocomposite Coatings from a Facile Exfoliation-Reassembly Process” filed Oct. 18, 2012, which is incorporated herein by reference in its entirety.

### STATEMENT REGARDING FEDERALLY SPONSORED RESEARCH OR DEVELOPMENT

This invention was made with government support under DMR-1205670 awarded by the National Science Foundation. The government has certain rights in the invention.

### BACKGROUND OF THE INVENTION

1. Field of the Invention

The invention generally relates to nanostructured polymer based hybrids. More particularly the invention relates to nanocoatings that include nanofillers, particularly layered nanosheets. 2. Description of the Relevant Art

Coatings have been widely used to serve multiple purposes, including protection, decoration, and generation of various surface functionalities, including printability, adhesion, optical properties, photo-sensitivity, and electrical/magnetic properties. It is highly desirable to create new coating technologies/formulations to lower cost but meanwhile improve performance. One of the directions is to create “nanocoatings”, which are coatings that have a very low thickness, and/or possess nano-scale microstructures. The low thickness can help reduce cost, while the well-designed microstructure is expected to improve performance and/or bring new functionality to the coated material.

Layer-by-layer (“LbL”) self-assembly has been well developed to form nanocoatings by alternately exposing a substrate to positively- and negatively-charged materials. While LbL has led to nanocoatings with extraordinary barrier properties and flame retardancy, this labor intensive and time-consuming process is not desirable in industry.

One of the key advantages of LbL assembled thin films, in comparison with the conventional nanocomposites, lies in the fact that LbL allows for the assembly of thin films containing a very high (>50 wt %) concentration of nanomaterials. This is difficult to achieve during the conventional nanocomposite preparation process, generally due to the extremely high viscosity of the composition when the nanomaterial concentration in the composition is high. The severe conflict between a high concentration of nanomaterial and a high viscosity prevents the design and preparation of high performance nanocomposites which requires a high filler loading. When the nanomaterials are in a 2-dimensional geometry (nanosheets) and in a high level of dispersion, the viscosity is even higher, leading to a virtually solid like state. Such a conflict has long been a key challenge to overcome in the nanocomposite research field.

### SUMMARY OF THE INVENTION

In an embodiment, a composition for coating a substrate includes: a nanomaterial; a binder; and a solvent that at least partially dissolves the binder; wherein the binder binds the nanomaterials together to form a continuous nanostructured coating as well as to bind the coating to the substrate. Exemplary nanomaterial include but are not limited to zero-dimensional nanoparticles, one-dimensional nanowires, nanotubes, nanorods, two-dimensional nanosheets, nanobelts, three-dimensional nanocages, nanocubes, or combinations thereof. In one embodiment, the nanomaterial comprises a natural or synthetic layered material. Exemplary layered materials include, but are not limited to, silicates, aluminosilicates, phosphates, phosphonates, graphene, exfoliated graphite, smectite clays, layered double hydroxides, metal oxides, metal chalcogenides, metal oxy-halides, metal halides, and hydrous metal oxides.

In an embodiment, the binder is a polymer. In further embodiments, the composition also includes a cross-linking compound capable of forming a covalent bond or any interaction with the polymer and/or the substrate. Alternatively, the binder may be a second nanomaterial having a charge opposite to the charge of the nanomaterial. A crosslinking catalyst at a very low concentration may also be included.

The concentration of the sum of the nanomaterials and binders in the composition ranges from about 0.001 wt % to about 60 wt %. The concentration ratio of nanomaterial to total amount of nanomaterial and binder ranges from about 5 wt % to about 99.9 wt %.

In a specific example, the nanomaterial is a layered material and the binder is a polymer. The nanomaterial may be a layered material having hydroxyl groups and the binder may be a polymer having hydroxyl groups. In such an embodiment, a cross-linking compound having, for example, at least two aldehyde functional groups may be used to couple the binder to the nanomaterial and form crosslinks with the binder.

In an embodiment, a method of coating a substrate includes applying a coating composition, as described above to a substrate and curing the coating composition. The coating composition may be applied using any process to apply liquid coatings, such as a dip coating process, a spray coating process, a spin coating process, a liquid jet printing process, or 3D printing process. In an embodiment, a force is applied to the coating composition prior to curing the coating composition, wherein the applied force causes at least a portion of the nanomaterials to become aligned. The applied force may be any physical/chemical force, such as a gravitational force, a mechanical force or a centrifugal force.

In some embodiments, the coating composition includes a cross-linking compound. Curing the coating composition may include initiating a cross-linking reaction between the cross-linking compound and the binder and/or nanomaterials. The cross-linking reaction may be thermally initiated, chemically initiated, or initiated by radiation, such as UV light.

The substrate may be made of any materials, such as a polymer, glass, wood, paper, a ceramic, metal, metal alloy, or any combination of these materials. The substrate may be flat, curved or irregular.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic diagram of a dip coating process;

FIG. 2 depicts a schematic drawing of the co-assembly process to prepare a nanocoating;

FIG. 3 depicts a schematic drawing of exfoliation of ZrP and recovery of hydroxyl groups with an acid treatment;

FIG. 4A depicts the co-crosslinking reaction between PVA and ZrP by glutaraldehyde;

FIG. 4B depicts a schematic drawing (not to scale) of crosslinking between ZrP nanosheets and PVA chains to form an integrated nanostructure;

FIG. 5 depicts neat PVA and PVA/ZrP (20 wt %) nanocoatings on a polylactic acid film surface;

FIG. 6 depicts a TEM image of the PVA/ZrP (20%) nanocoating on a polylactic acid film surface;

FIG. 7 depicts an FTIR spectra of MMT, PVA, PVA-C, PVA/MMT-50, and PVA/MMT-50-C;

FIG. 8 depicts a UV-Vis spectra of the coated PLA films;

FIG. 9 depicts XRD patterns of MMT and PLA/MMT nanocoatings;

FIG. 10 depicts XRD patterns of crosslinked and un-crosslinked PVA/MMT nanocoatings;

FIG. 11A depicts a TEM image of a PVA/MMT nanocoating containing PVA/MMT-20;

FIG. 11B depicts a TEM image of a PVA/MMT nanocoating containing PVA/MMT-30;

FIG. 11C depicts a TEM image of a PVA/MMT nanocoating containing PVA/MMT-40;

FIG. 11D depicts a TEM image of a PVA/MMT nanocoating containing PVA/MMT-50 (low magnification to show the film structure and thickness);

FIG. 11E depicts a TEM image of a PVA/MMT nanocoating containing PVA/MMT-50;

FIG. 11F depicts a TEM image of a PVA/MMT nanocoating containing PVA/MMT-60;

FIG. 12A depicts an SEM image of a fractured cross-section of PVA/MMT-50-C;

FIG. 12B depicts an SEM image of a cross-section of PVA/MMT-50-C residue after 1000° C. thermal treatment;

FIGS. 13A and 13B depict mechanical properties of free standing nanocoatings; and

FIG. 14 depicts a digital picture of coated PET film after burning for 10 seconds.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Herein, we disclose a facile nanocoating technology which can overcome the above-mentioned difficulties through a simple strategy of introducing solvent into a nanocomposite coating composition. In this way, even if the nanomaterial concentration is very high with respect to the sum of nanomaterial and binder, the addition of solvent can always effectively lower the viscosity to enable the system to be processable, as long as the nanomaterials can be dispersed in the selected solvent and the binder can be at least partially dissolved in the solvent. Maintaining a low viscosity nanocomposite coating composition also allows one to achieve a high processing rate, and further allows manipulation of the microstructure during the processing. Through the incorporation of a high concentration of nanomaterial components and by being able to orient the nanomaterials and further integrate nanomaterials with the binder (e.g., via co-crosslinking with a polymer binder), the formed nanocoatings can possess: (1) excellent barrier performance; (2) superior mechanical properties, and (3) excellent flame retardancy. Furthermore the disclosed nanocoatings may be easily formed using currently available industrial equipment. Therefore, such a nanocoating technology can be easily scaled up at a low cost.

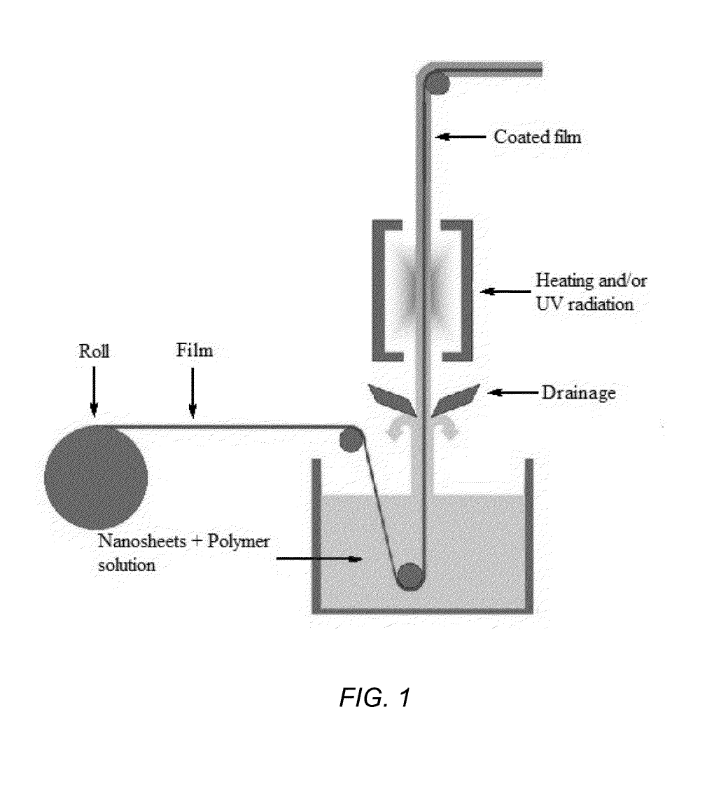

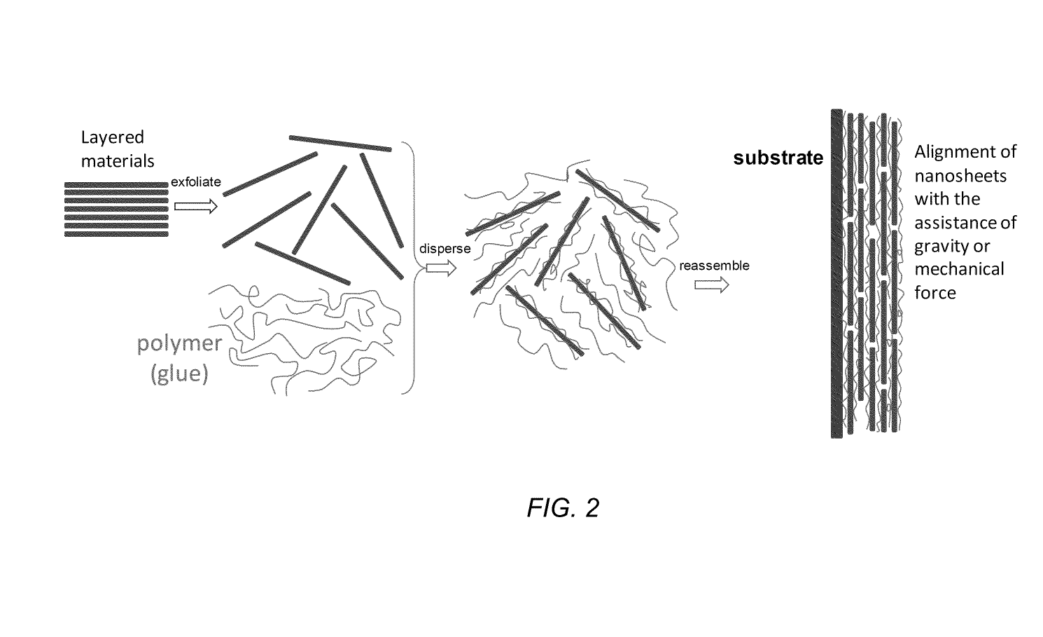

Unlike LbL, which is carried out step by step, the coating process disclosed herein is designed to be achieved via a one-step co-assembly of binders and nanomaterials and thus can be operated continuously, as briefly shown in FIG. 1. Generally, the process involves the co-assembly of nanosheets with a selected binder, which binds the nanomaterials together to form a continuous nanostructured coating as well as to binder the coating to the substrate. During the assembly process, the nanomaterials can be well aligned by any type of forces, including gravity, mechanical/shear force, or centrifugal force. Moreover, if needed, the fillers can be covalently linked to the binder and/or the substrate, which helps to cure the nanocoating and fix the micro-structure of the nanocoating, leading to significantly improved mechanical and barrier properties and flame retardancy. FIG. 2 depicts a schematic diagram of this process.

A nanocomposite coating may be formed using a nanocomposite coating composition. In one embodiment, a nanocomposite composition includes a nanomaterial; a binder; and a solvent that at least partially dissolves the binder; wherein the binder binds the nanomaterials together to form a continuous nanostructured coating as well as to binder the coating to the substrate.

The term “nanomaterial” as used herein refers to any material that has a dimension that is less than 1 micron. Nanomaterials include zero-dimensional nanoparticles, one-dimensional nanowires, nanotubes, nanorods; two-dimensional nanosheets, nanobelts, three-dimensional nanocages, nanocubes, or combinations thereof. Zero-dimensional nanomaterials include nanoparticles such as nanoparticles of metal compounds, carbon, and organic compounds.

One-dimensional nanomaterials have a diameter of less than 1 micron. Exemplary one-dimensional nanomaterials include, but are not limited to, nanotubes, nanowires, and nanorods. Materials used to form one-dimensional nanomaterials include, but are not limited to, carbon, silicon, silicon dioxide, boron nitride, tungsten(IV) sulfide (WS₂), molybdenum disulfide (MoS₂), tin(IV) sulfide (SnS₂), titanium dioxide (TiO₂), indium phosphide (InP), gallium nitride (GaN), gold, and zinc oxide (ZnO). One-dimensional nanotubes may also be formed from transition metal/chalcogen/halogenides, described by the formula TM₆C_{y}H_{z}, where TM is a transition metal (e.g., molybdenum, tungsten, tantalum, niobium), C is chalcogen (e.g., sulfur, selenium, tellurium), H is a halogen (e.g., iodine), and 8.2<(y+z)<10.

Two-dimensional nanomaterials are materials that have a thickness of less than 1 micron, but have an unlimited surface area (i.e., unlimited length and width). Exemplary two dimensional nanomaterials include, but are not limited to, nanosheets and nanobelts. In one embodiment, a two-dimensional nanomaterial can be obtained by exfoliating a layered material into individual nanosheets. A layered material is a material that is composed of multiple sheets that are assembled in a layered architecture. Examples of layered materials include, but are not limited to, silicates, aluminosilicates, phosphates, phosphonates, graphene , exfoliated graphite, smectite clays, layered double hydroxides. In some embodiments, metal compounds (e.g., metal oxides, metal chalcogenides, metal oxyhalides, metal halides, and hydrous metal oxides) may be formed as a layered material. Layered materials may be naturally occurring or synthetic. Examples of naturally occurring layered materials include montmorillonite, hectorite, saponite, nontronite, stevensite, beidellite, hydrotalcite, kaolinite, dickite, nacrite, sepiolite, and attapulgite. Layered double hydroxides include compounds having the general structure:

[M(II)₁₋ₓM(III)ₓ(OH)₂]^{x+} (Aⁿ⁻_{x/n}).mH₂O

wherein M is a metal with either a 2⁺ or 3⁺ charge, A is an anion, which may be a carbonate, sulfate, perchlorate, halogen, nitrate, transition metal oxide, or any one of many other negatively charged ions, and values of x may lie in the range of 0.1 to 0.5. Synthetic layered materials include layered phosphate compounds of zirconium, titanium, tin, cerium, and thallium. Metal chalcogenides include metal monochalcogenides and metal dichalcogenides. Metal monochalcogenides include compounds having the formula ME, where M=a transition metal and E=S, Se, Te. Metal dichalcogenides include compounds having the formula ME₂, where M=a transition metal and E=S, Se, Te.

Three-dimensional nanomaterials are compounds that are not confined to nanometer range in any dimension, but are composed of nanomaterials (e.g., one-dimenstional and/or two-dimensional nanomaterials) or possess a nanostructure. Exemplary three dimensional nanomaterials include, but are not limited to nanocages, nanocubes.

The binder is a compound chosen to bind the nanomaterials together to form a continuous nanostructured coating as well as to binder the coating to the substrate. In one embodiment, the binder is a polymer. Generally, any polymer which is capable of binding to the substrate and the nanomaterial may be used. Binding, in the context of this application, refers to any interaction between the components, including covalent bonding, ionic bonding, hydrogen bonding, Van der Waals force, and inclusion of the nanomaterial. Exemplary polymers that may be used to bind the nanomaterials include, but are not limited to, polyesters, polyvinyl alcohol, polyvinyl amine, polyurethane, polyacrylates, or mixtures thereof.

In some embodiments, a cross-linking compound may be used to form a covalent bond between the polymer binder and the substrate and/or the nanomaterial. In some embodiments, a cross-linking compound may be a homobifunctional linker. Such compounds may have the general formula R—(CH₂)ₙ—R, where R is CO₂H, NH₂, OH, SH, CH═O, CR₁═O, CH═NH, or halogen; n is 1-200, and R₁ is C₁-C₆ alkyl. Alternatively, the linker may be a heterobifunctional linker. Such compounds may have the general formula R₂—(CH₂)ₙ—R₃, where R₂ and R₃ are different, and where each R₂ and R₃ is CO₂H, NH₂, OH, SH, CH═O, CR₁═O, CH═NH, or halogen; n is 1-200, and R₁ is C₁-C₆ alkyl. A cross-linking compound may bond with at least one reactive functional group of the polymer and at least one reactive functional group of the substrate or nanomaterial. In some embodiments, the cross-linking compound forms covalently bonds with two or more functional groups of a polymer binder, to cross-link the binder to cure the nanomaterials into polymer, and cure the nanocoating onto the substrate. In some embodiments, a cross-linking compound may be a multifunctional linker.

Alternatively, the binder may also be a second nanomaterial having a charge that is opposite to the charge of the nanomaterial. For example, the nanomaterial may be a negatively charged clay mineral such as montmorillonite, hectorite, saponite, stevensite, or beidellite. The negatively charged nanomaterial may be bound to a substrate (preferably a negatively charged substrate) using a positively charged layer material (e.g., layered double hydroxides).

The solvent may be any liquid compound (during coating conditions) that at least partially dissolves the binder. Solvents include suitable organic and inorganic solvents. Solvents may be polar or non-polar solvents, usually based on the nature of the binder. Exemplary solvents include water, acetone, ethanol, tetrahydrofuran (THF).

The nanocomposite coating composition is characterized by having a high nanomaterial concentration with respect to the total amount of nanomaterial and binder, but also having a viscosity that allows easy application of the nanocomposite coating composition. In one embodiment, the viscosity of the nanocomposite coating composition is controlled by maintaining the total amount of nanomaterials and binders in the nanocomposite coating composition from about 20 wt % to about 95 wt %. A controlled viscosity composition may be obtained. In one embodiment, the concentration ratio of nanomaterial to total amount of nanomaterial and binder ranges from about 5 wt % to about 99.9 wt %. As shown in the examples below, improved coatings may be achieved when the concentration of nanomaterial in the nanocomposite coating composition is greater than about 20 wt %, up to about 90 wt %. Preferably, the concentration of nanomaterial in the nanocomposite coating composition is between 30 wt % and 85 wt %.

In an embodiment, the nanocomposite coating composition is applied to a substrate and cured to form a coating of the substrate. In some embodiments, the coating is a nanocoating. When formed as a nanocoating the coating may have a thickness of less than about 1 μm. In a preferred embodiment, the nanocoating has a thickness of less than 500 nm or less than 100 nm.

Many different processes may be used to apply the nanocomposite coating composition to the substrate. Dip coating may be used to apply the nanocomposite coating composition to the substrate. In dip coating a substrate is immersed in the nanocomposite coating composition. The substrate remains for a time sufficient to ensure that the substrate has been coated with the nanocomposite coating composition. The substrate is then removed from the nanocomposite coating composition leaving a film of the nanocomposite coating composition on the substrate, with the excess liquid draining from the substrate or removed by a tool. After removal from the nanocomposite coating composition the coated substrate may be passed into a curing chamber where solvent from the nanocomposite coating composition is removed and any final curing processes may be performed.

An exemplary dip coating system used for forming a nanocomposite coating on a film is depicted in FIG. 1. A roll of material to be coated is passed into a container that includes the nanocomposite coating composition. A series of rollers may be used to ensure that the film is maintained within the nanocomposite coating composition to allow the film to be sufficiently coated. The film is drawn vertically from the nanocomposite coating composition to allow the film to be vertically drained of excessive composition. Maintaining the film in a vertical position also helps to align the nanomaterial due to gravitational forces and flow force applied to the nanomaterials. The film may be carried into a curing chamber where heat and/or UV radiation is applied to the film to cure the binder and remove excessive solvent (e.g., by heat assisted evaporation). The coated film may be removed from the chamber and collected for use. If needed, the coating process can be repeated.

Other process may be used to apply the nanocomposite coating composition to the substrate. Other processes include, but are not limited to, spray coating processes, spin coating processes, liquid jet printing processes, and 3D printing processes.

In some embodiments, the properties of a nanocomposite coating may be altered by aligning the nanomaterials within the applied nanocomposite coating composition. Alignment of the nanomaterials may be accomplished by applying a force to the applied nanocomposite coating composition that causes at least partial alignment of the nanomaterials. Forces that may be used to align the nanomaterials include, but are not limited to, gravitational force, mechanical forces or centrifugal forces. Incorporation of any extra nanomaterials may bring additional functionality.

The substrate may be in any shape and composed of any material. Exemplary materials include polymers, glass, wood, paper, ceramics, metals, metal alloys, or any combination of these materials. The substrate may be in any form including flat, curved, or irregular. The substrate may be in the form of a sheet, or film, or the surface of a bulk material.

In a particular embodiment, a substrate may be coated with a nanocomposite coating composition that includes a polymer, a nanomaterial that is a layered material, and a solvent. A schematic diagram of a coating process using a layered material is shown in FIG. 2. When using a layered material it may be beneficial to exfoliate the layered material (i.e., separate the layers) prior to use in the nanocomposite coating composition. Layered materials may be exfoliated by use of oxidants, ion intercalation/exchange, or surface passivation by solvents. For example, the addition of amines or ammonium ions to a layered compound can cause the layers to separate. The result of exfoliation is a plurality of solvent separated nanosheets that can be reassembled on the substrate.

As shown in FIG. 2, the exfoliated layers may be combined with the polymer to form a composition that includes separated nanosheets dispersed with the polymer. Once applied to the substrate the separated nanosheets may be realigned by gravitational or any other types of forces. Curing of the polymer may produce a coating that includes the layers of the nanomaterial bound to the substrate by the polymer, and the layers of the nanomaterial are co-crosslinked with the polymer.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

### Polyvinyl Alcohol/α-Zirconium Phosphate (PVA/ZrP) Nanocoating

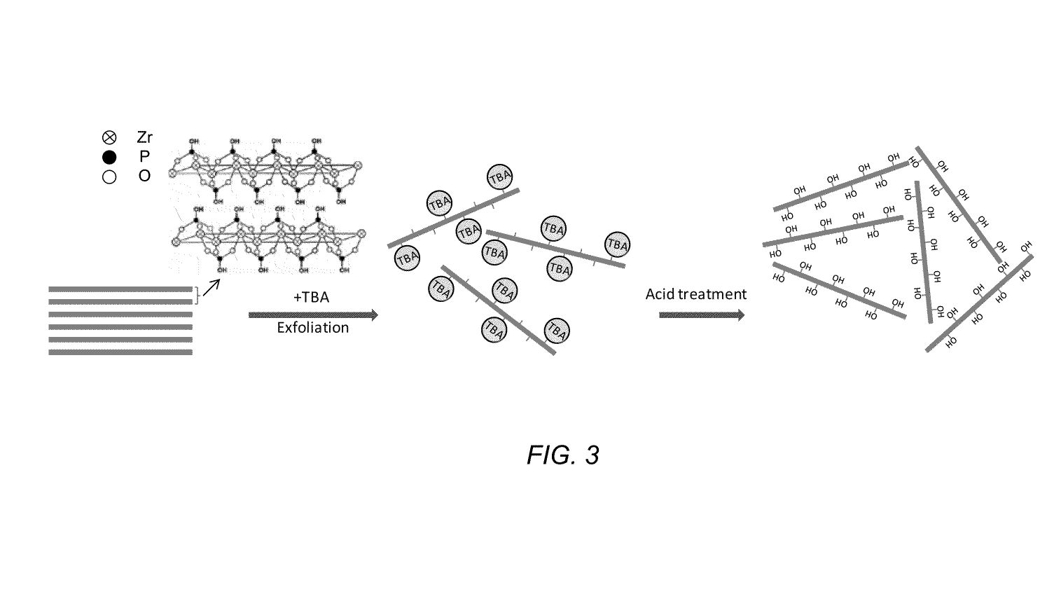

Layered ZrP micro-crystals were used to coat a substrate according to the process schematically illustrated in FIG. 3. Layered ZrP micro-crystals were completely exfoliated into individual nanosheets using tetra-n-butyl ammonium hydroxide or propyl amine. A subsequent acid treatment helped to recover the —OH groups on the nanosheet surface. The protonated ZrP nanosheets were collected by centrifugation, and re-dispersed in water with the help of ultrasonication. Depending on the specific application, the protonated ZrP nanosheets could also be dispersed into other solvents such as acetone, ethanol, tetrahydrofuran (THF), etc. The fully exfoliated ZrP nanosheets can be uniformly dispersed and well aligned in various polymer matrices. Significant property improvements have been achieved.

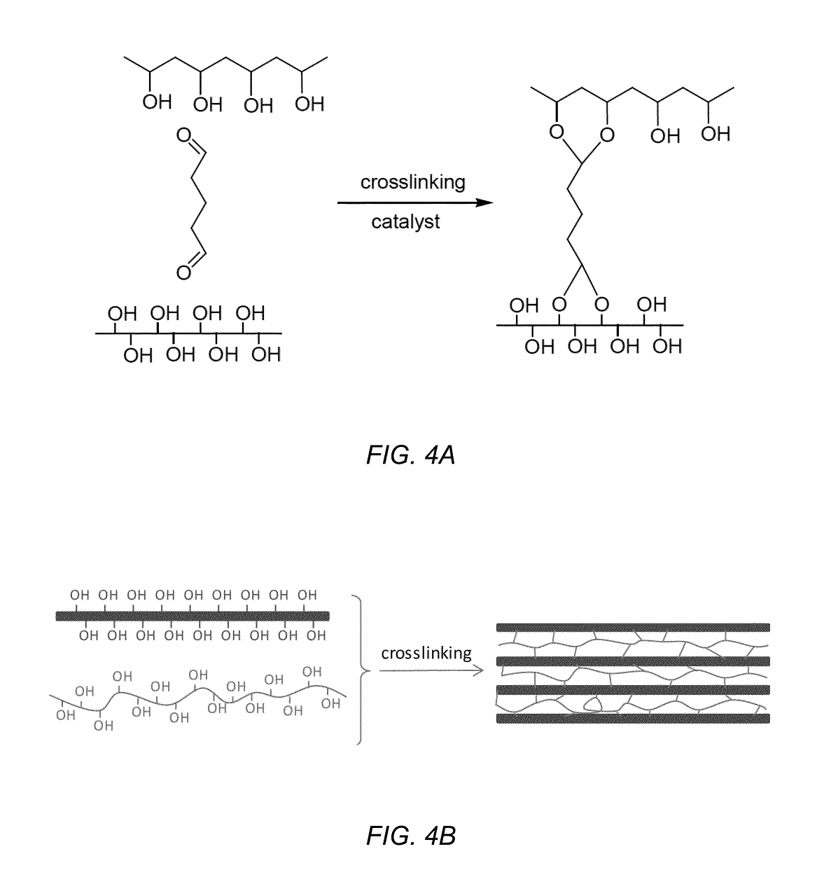

The exfoliated and protonated ZrP nanosheets were incorporated into a polyvinyl alcohol (PVA, Mowiol® 8-88 from Kuraray) aqueous solution containing a pre-determined amount of glutaraldehyde, which serves as a crosslinking agent, as depicted schematically in FIG. 4A. After a substrate (a polylactic acid film here, could be any even or uneven substrate) was dip coated by the nanocomposite coating composition composed of PVA, dispersed ZrP nanosheets, and water, the substrate was placed vertically, allowing the nanosheets to become aligned by the gravity. During the drying of the nanocoating, the nanosheets were crosslinked with PVA, as depicted schematically in FIG. 4B, assisted by heating, forming a well-structured thin coating. The concentration of nanosheets in PVA can be easily controlled by varying the number of times the substrate is dipped into the nanocomposite coating composition, varying the concentration of ZrP in the coating composition, and varying the viscosity of the coating composition. For certain applications where the nanocoatings will not experience high humidity environment, crosslinking may not be necessary.

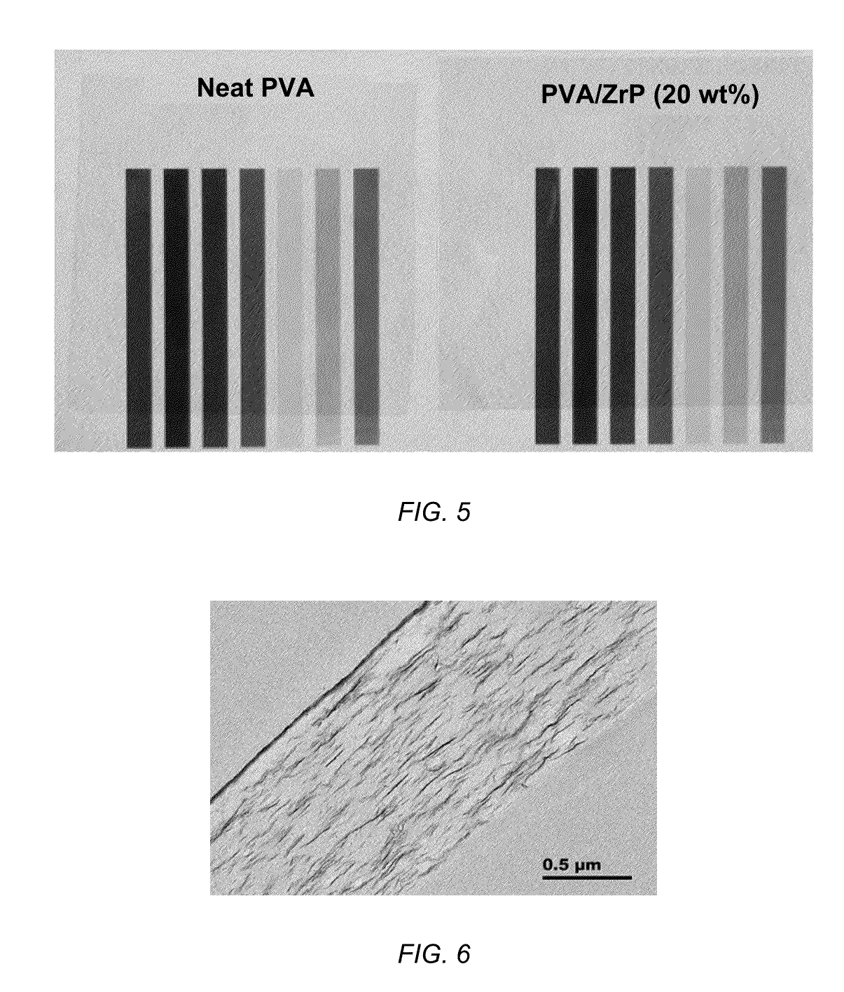

The formed PVA/ZrP nanocoating on polylactic films is shown in FIG. 5. The PVA/ZrP nanocoating maintained high transparency, because of the very low thickness of the individual ZrP nanosheets and a high level of dispersion of such nanosheets, both of which help minimize light scattering. FIG. 6 shows the transmission electron microscopy (TEM) image of the PVA/ZrP (20 wt %) nanocoating. The nanosheets exhibited highly ordered orientation along the polymer film surface, and the coating thickness is ca. 1 μm.

### EXAMPLE 2

### Studies of Various MMT/PVA Coatings

In this example, nanosheets montmorillonite (MMT) were used to coat a PLA film according to the process schematically illustrated in FIG. 2. PLA is used as the binder and water as the solvent. Poly(vinyl alcohol) (PVA) (Mowiol® 8-88 from Kuraray), sodium montmorillonite (MMT) (Cloisite Na⁺, Southern Clay Products), glutaraldehyde (GA) (Aldrich Chemical Co. 50% w/w), and polylactic acid (PLA) bi-axially oriented films (from BI-AX International Inc.) were used as received.

A sample of PVA was pre-dissolved in de-ionized (DI) water, and a sample of MMT was pre-exfoliated in DI water to form a suspension, which was stirred for 1 hour and ultra-sonicated for another 1 hour to promote the exfoliation. The PVA solution was then added into the MMT/water suspension during stirring to form a 1.50 wt % suspension (based on the total mass of MMT and PVA). This concentration can be adjusted from 0.0001 to 60 wt % for different applications and depending on the selection of the nanosheets, polymer matrix, and solvent, as well as the ratio of nanosheets/polymer matrix. The 1.50 wt % is just an example which works well for PVA and MMT in water. The mixture was stirred for 30 min and ultra-sonicated for another hour. The crosslinking agents GA and HCl were added to the mixture. The PLA films (ca. 15 cm×20 cm) were coated four times by dipping them into the above mixture solution and then were hung along four different edges and dried in an oven at 60° C., during which the nanosheets were oriented by gravity, and the coating was crosslinked. The purpose to hang the samples along the four different edges (directions) is to minimize the thickness gradient and achieve highest possible uniformity. The samples were named as PVA/MMT-X-C, where X is the mass concentration of MMT in the sum of PVA and MMT; and C refers to crosslinking. Corresponding controls samples which were not crosslinked were named as PVA/MMT-X. Controls samples of neat PVA and crosslinked PVA (PVA-C) were also prepared.

X-ray diffraction (XRD) patterns of the samples were recorded on a Bruker D8 diffractometer with Bragg-Brentano 0-20 geometry (30 kV and 40 mA), using a graphite monochromator with Cu Ka radiation. The thermal stability of the nanocoatings was characterized by a thermogravimetric analyzer (TGA, TA Instruments model Q50) under an air atmosphere (40 mL/min) at a heating rate of 10° C./min. Fourier transform infrared spectrophotometry (FTIR) spectra of the samples were recorded in the range of 4000 to 500 cm⁻¹ on a PerkinElmer Spectrum 100 Fourier transform spectrometer using film sample. Ultraviolet-visible spectrophotometry (UV-Vis) spectra of the films were recorded using a CARY 100 Bio UV-Visible spectrophotometer (Varian). The nanocoating films were first embedded in epoxy. The cured epoxy capsules containing the coated films were then trimmed and microtomed into ca. 80 nm thick slices, which were collected on copper grids. TEM images of the cross-section of the nanocoatings were obtained with an JEOL TEM with an acceleration voltage of 120 kV. SEM images of the samples were acquired on a FEI Helios Nanolab 400. The samples were sputter coated with a thin layer (ca. 3 nm) of Au/Pd prior to SEM imaging. The oxygen transition rate of the samples was measured using a Y202D oxygen permeation analyzer (GBPI Packing Test Instrument Co. Ltd, Guangzhou, China) in accordance with ASTM Standard D-3985 at 23° C. and 0% RH. Prior to the testing, the oxygen permeation analyzer was calibrated by the standard films from NIST. The water vapor transition rate (WVTR) of the samples was measured on a WVTR 7500 analyzer (PERMATRAN-W Model 3/61, Mocon, Inc., USA) in accordance with ASTM Standard F-1249) at 23° C. and 50% RH. The tensile properties were tested at 25° C. and 30% relative humidity by a dynamic mechanical analyzer (DMA, TA Instruments model Q800) under the module of DMA strain rate at 10.0%/min. The films were cut into a size of 4 Mm×30 mm. The samples were dried in an oven at 105° C. for 5 hours and were then equilibrated in ambient conditions (ca. 22° C., 25% relative humidity) for 24 hours prior to mechanical testing.

### RESULTS AND DISCUSSION

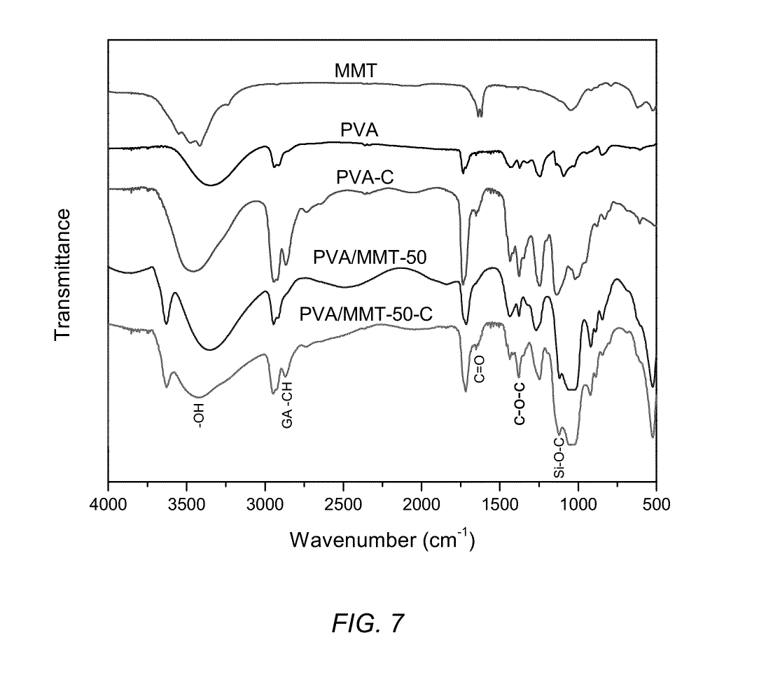

The FTIR spectra of PVA, PVA-C, PVA/MMT-50, PVA/MMT-50-C, and MMT are shown in FIG. 7. The presence of the peak at 1377 cm⁻¹ (C—O—C) for samples PVA-C and PVA/MMT-50-C suggests the reaction between the hydroxyl groups in PVA and the aldehydes.

Meanwhile the peak at 1120 cm⁻¹ for PVA/MMT-50-C, which is associated with the formation of —Si—O—C— bonds corresponding to the reaction between MMT (Si-OH) and GA/PVA. A new peak at 3630 cm⁻¹ attributed to the water formed during the above reaction further support the above reaction. From the above spectral changes, one can conclude that MMT and PVA have been co-crosslinked to form an integrated structure.

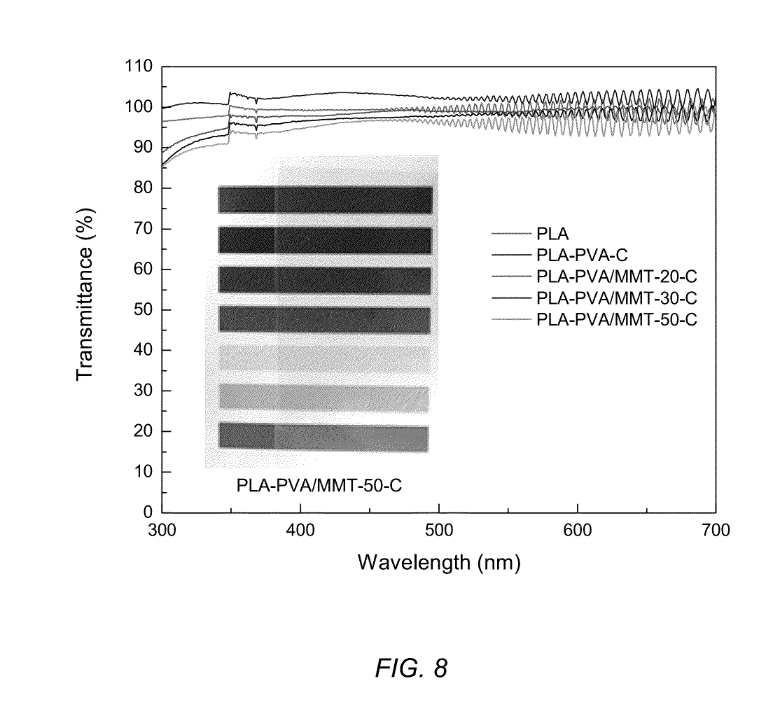

Due to the high level of dispersion and very low thickness, the coated PLA films were highly transparent (FIG. 8). Even when a nanocoating containing 50 wt % MMT was applied, the overall transparency maintained at ca. 95% of the non-coated PLA. In addition, the Fabry-Perot patternson was clearly observed in the UV-Vis spectra, which indicates that the films possess a high level of uniformity. Such a feature is very beneficial for applications that required a high transparency, such as packaging.

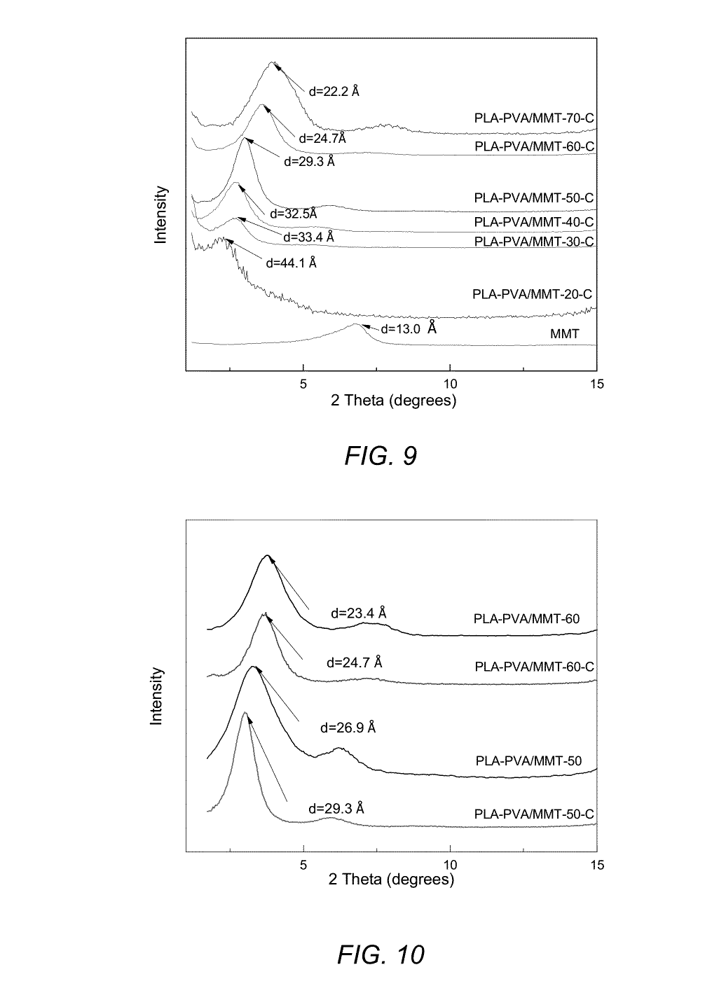

The structure of the PVA/MMT nanocoatings was characterized by X-ray diffraction as shown in FIGS. 9 and 10. With an increasing concentration of MMT in the PVA/MMT nanocoatings, the interlayer distance of the MMT layers gradually decreased from 44.1 to 22.2 A, which is expected since less PVA chains were sandwiched between MMT layers. It was also observed that the interlayer distance of the crosslinked nanocoatings was slightly larger than that of the non-crosslinked ones. This phenomenon is probably because of two reasons: (1) the crosslinking lowered the degree of PVA chain mobility and thus PVA chains are worse packed, (2) crosslinking occurred before the complete orientation of MMT and PVA chains.

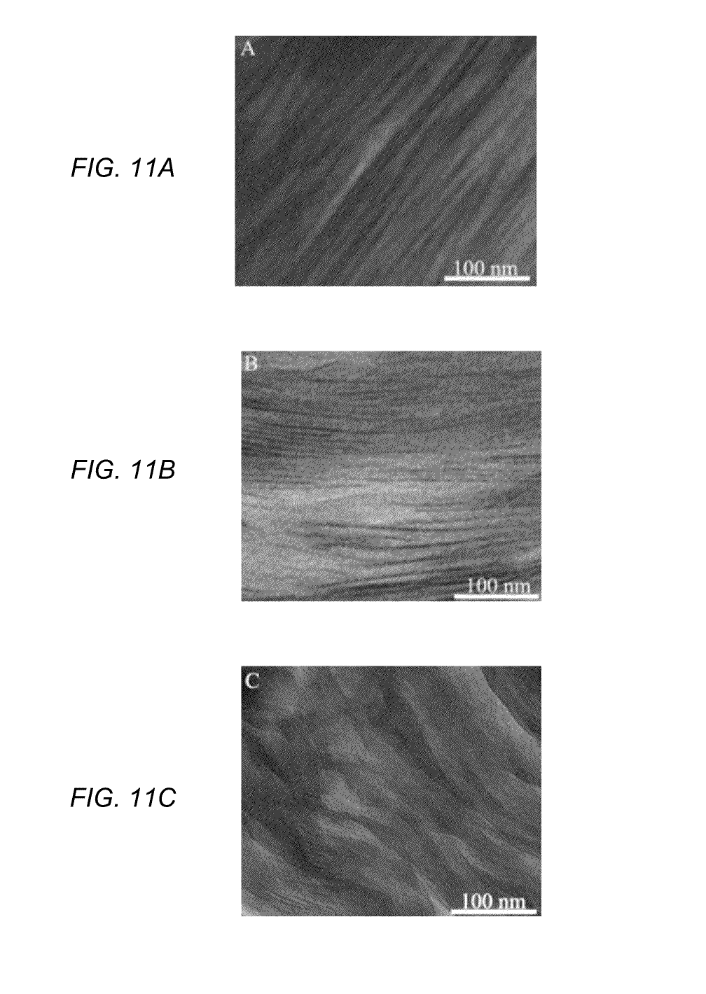

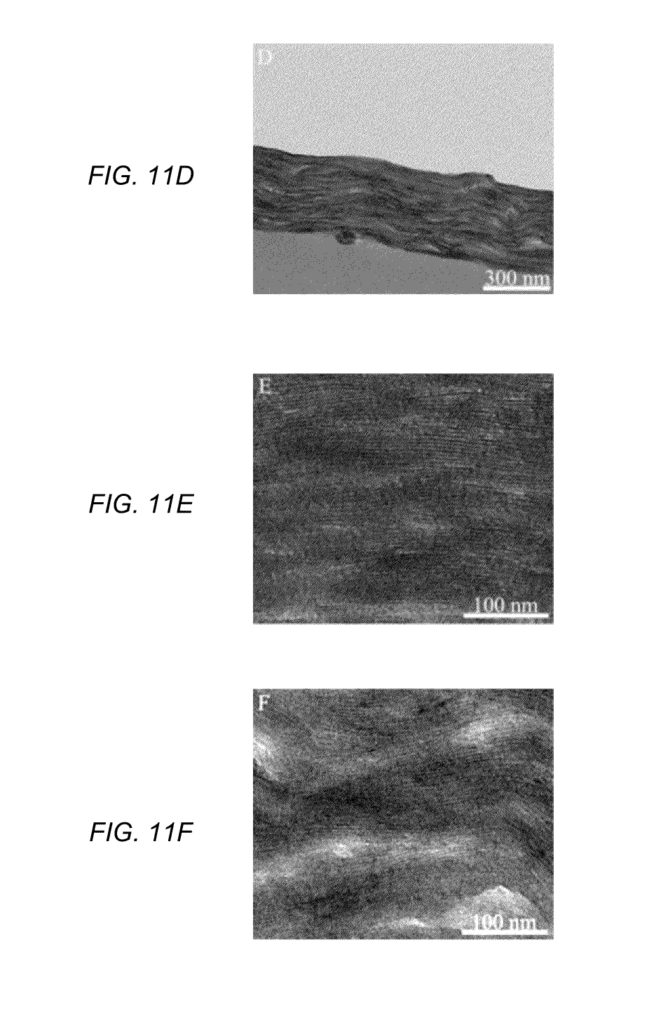

While the XRD characterization has shown that the assembled nanocoatings possess a highly ordered layered structure, the details of the layered structure were characterized by TEM. FIGS. 11A-E show the morphology of the cross-section of the co-assembled nanocoatings. With an increasing concentration of MMT in the nanocoating, the MMT nanosheets in the nanocoatings became to exhibit a higher level of orientation. In particularly, the MMT nanosheets in the PVA/MMT-50-C nanocoating exhibited a highly ordered alignment, resembling the crystal structure of natural clay. This morphology is also consistent with the XRD patterns shown in FIG. 9, where the PVA/MMT-50-C nanocoating exhibited the narrowest diffraction peak width, suggesting a highest ordered layered structure. It is easy to understand the nanocoating would exhibit a higher level of orientation with an increasing concentration (from 20 to 50 wt %) of MMT nanosheets in the nanocoatings due the space refinement effect.

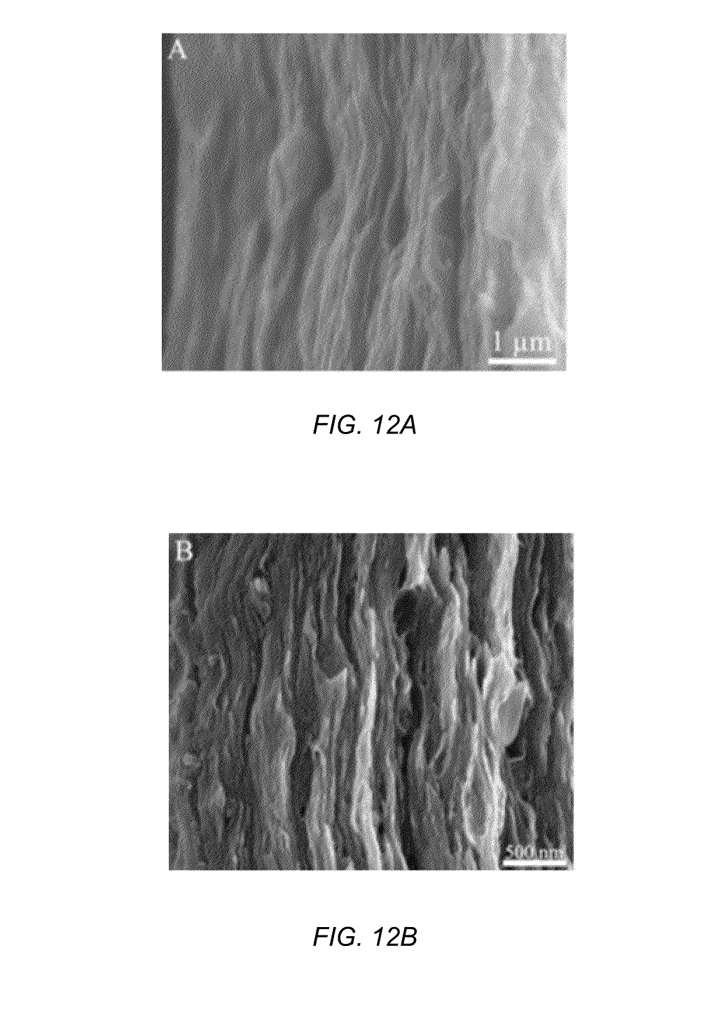

In addition to TEM, the fractured cross-section of the nanocoatings was also imaged under SEM, as shown in FIG. 12A and B, which also exhibited a highly ordered layered structure. Such a highly orientated and very closely packed layered structure is expected to lead to superior mechanical, barrier, and flame retardant properties.

As expected, the nanocoatings, although extremely thin (ca. 300 nm), exhibit superior oxygen barrier properties. PLA is known for its very poor oxygen barrier and thus not suitable for food packaging. PVA itself is a very effective oxygen barrier, but a layer of PVA coating can only lower the oxygen transmission rate (OTR) to ca. 9 cc/m²·day, which is still way above the typical food packaging requirement of ca. 2 cc/m²·day. With the incorporation of highly ordered MMT nanosheets into the nanocoating, the OTR rate can be significantly lowered to 0.58 cc/m²·day for the sample containing 50 wt % MMT. The OTR was reduced to be lower that the detection limit (0.02 cc/m²·day) when 70 wt % of ordered MMT nanosheets were aligned in the nanocoating. Such a dramatically lowered OTR is simply owing to many layers of highly ordered MMT nanosheets, which leads to a very tortuous oxygen penetration path, thus effectively blocking the oxygen penetration. It was observed that the crosslinked nanocoatings exhibited a slightly high OTR compared to the corresponding non-crosslinked ones. This is probably owing to their slightly higher interlayer distance, as discussed above.

TABLE 1
OTR of coated PVA films.

| Formulation | OTR cc/(m² · day) |
|---|---|
| Testing condition | 23° C., 0% RH |
| PLA | 846.6 |
| PLA-PVA | 16.1 |
| PLA-PVA-C | 16.5 |
| PLA-PVA/MMT-20-C | 3.6 |
| PLA-PVA/MMT-30-C | 1.5 |
| PLA-PVA/MMT-40-C | 0.6 |
| PLA-PVA/MMT-50-C | 0.2 |
| PLA-PVA/MMT-50 | 0.2 |
| PLA-PVA/MMT-60-C | 0.2 |
| PLA-PVA/MMT-60 | 0.2 |
| PLA-PVA/MMT-70-C | 0.1 |

The highly ordered nanosheets also lead to significant reinforcing effect, especially when they were co-crosslinked with the PVA matrix, exhibiting extremely high stiffness and strength.

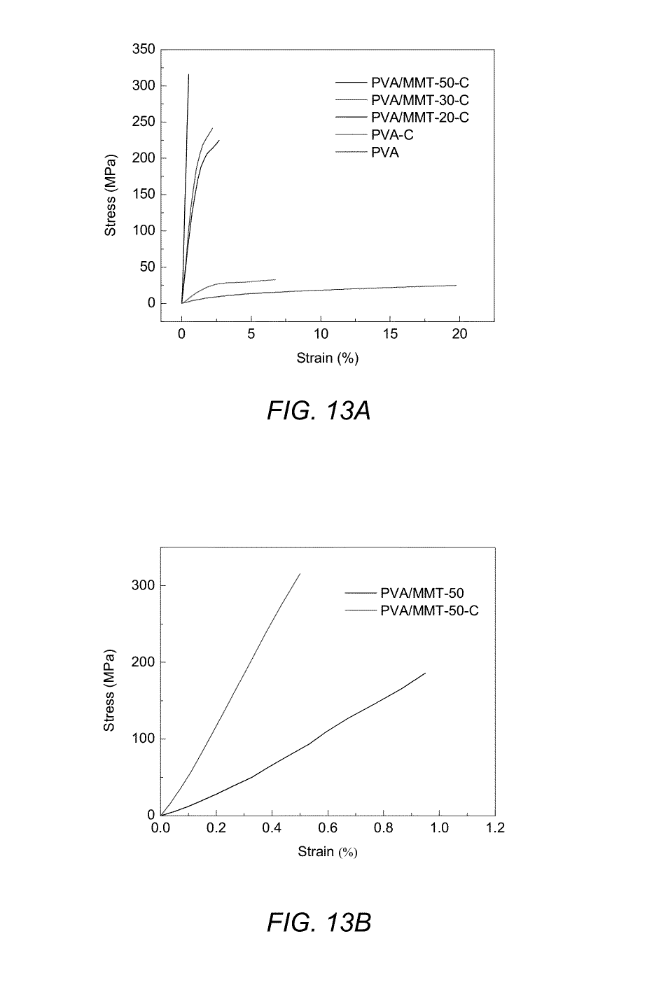

As shown in FIGS. 13A and 13B and Table 2, with the incorporation of highly ordered MMT nanosheets in PVA nanocoating, both the tensile strength and modulus increased dramatically, even at a concentration of 20 wt %. At 50 wt % of MMT incorporation, the nanocoating exhibited a modulus of 65 GPA, which is ca. ⅓ of the modulus of stainless steel and a tensile strength of ca. 316 GPa, which is close to that of aluminum.

As expected, co-crosslinking leads to effective load transfer from PVA matrix to MMT nanosheets. The stiffness of the crosslinked nanocoating is ca. 3 times higher than that of the un-crosslinked counterpart.

TABLE 2
Mechanical properties of PVA and its nanocomposites.

| | Tensile strength | Modulus | Ultimate |
|---|---|---|---|
| Sample | (MPa) | (GPa) | strain (%) |
| PVA | 24.8 ± 2.2 | 0.5 ± 0.1 | 19.8 ± 2.3 |
| PVA-C | 32.3 ± 2.6 | 1.5 ± 0.2 | 6.7 ± 0.8 |
| PVA/MMT-20-C | 224.6 ± 18.6 | 16.8 ± 2.1 | 2.7 ± 0.5 |
| PVA/MMT-30-C | 241.4 ± 24.1 | 20.0 ± 2.8 | 2.2 ± 0.3 |
| PVA/MMT-50-C | 315.7 ± 28.2 | 65.0 ± 4.8 | 0.5 ± 0.1 |
| PVA/MMT-50-C | 185.9 ± 20.6 | 20.0 ± 2.5 | 1.0 ± 0.2 |
| Aluminum alloy | 185 | 70 | — |
| 2014 (annealed)* | | | |
| Stainless steel AISI 304* | 550 | 195 | — |

Properties of Commercial Metals and Alloys. In CRC Handbook of Chemistry and Physics, 90th ed.; Lide, D. R., Ed. CRC Press/Taylor and Francis: Boca Raton, FL, 2010.

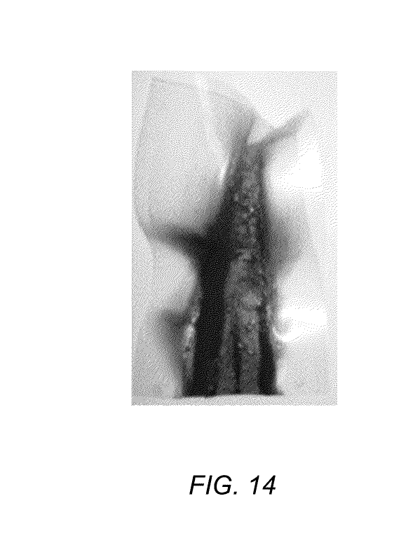

The insulating and blocking effect (as demonstrated in the oxygen barrier test already) also leads to significant improvement in flame retardancy. We have carried out the burning test on various polymer films coated with PVA/MMT nanocoating, and found many of them can be barely ignited. FIG. 14 shows a digital picture of a polyethylene terephthalate (PET) film coated with PVA/MMT-50-C after 10 seconds of burning. The film can be barely ignited, showing excellent flame retardancy.

We have demonstrated that very high concentrations of nanosheets can be incorporated into polymer matrices to form highly ordered nanocomposites, as long as a solvent is added to adjust the viscosity. With the incorporation of a high concentration of highly oriented nanosheets, the nanocoatings exhibit extremely high stiffness and strength, superior oxygen barrier, and outstanding flame retardancy, especially when the nanosheets are co-crosslinked with the polymer matrix (binder).

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A composition for coating a substrate comprising: a nanomaterial; a binder; and a solvent that at least partially dissolves the binder; wherein the binder binds the nanomaterials together to form a continuous nanostructured coating, and wherein the binder binds the coating to the substrate, wherein the concentration of nanomaterial in the composition is greater than 20 wt %.

2. The composition of claim 1, wherein the concentration of nanomaterial in the composition is between 30 wt % and 85 wt %.

3. The composition of claim 1, wherein the nanomaterial is in the form of zero-dimensional nanomaterials, one-dimensional nanomaterials, two-dimensional nanomaterials, three-dimensional nanomaterials, or combinations thereof.

4. The composition of claim 1, wherein the nanomaterial comprises two-dimensional nanosheets from a natural or synthetic layered material.

5. The composition of claim 1, wherein the binder comprises a polymer.

6. The composition of claim 1, further comprising a cross-linking compound capable of interacting with the binder and/or interacting with both the binder and the nanomaterial.

7. The composition of claim 1, wherein the concentration of nanomaterials and binders in the composition ranges from about 20 wt % to about 95 wt %.

8. The composition of claim 1, wherein the concentration ratio of nanomaterial to total amount of nanomaterial and binder ranges from about 5 wt % to about 99.9 wt %.

9. The composition of claim 1, wherein the nanomaterial is a layered material having hydroxyl groups and wherein the binder is polymer having hydroxyl groups.

10. A method of coating a substrate comprising:
applying a coating composition to a substrate, the coating composition comprising:
a nanomaterial; a binder; and a solvent that at least partially dissolves the binder;
wherein the binder binds the nanomaterials together to form a continuous nanostructured coating, and wherein the binder binds the coating to the substrate;
applying a force to the applied coating composition prior to curing the coating composition, wherein the applied force causes at least a portion of the nanomaterials to become aligned in a direction associated with the applied force; and
curing the coating composition.

11. The method of claim 10, wherein the coating composition is applied using a dip coating process.

12. The method of claim 10, wherein the applied force comprises a gravitational force.

13. The method of claim 10, wherein the applied force comprises a mechanical force.

14. The method of claim 10, wherein the applied force comprises a centrifugal force.

15. The method of claim 10, wherein curing the coating composition comprises heating the coating composition.

16. The method of claim 10, wherein curing the coating composition comprises applying radiation to the coating composition.

17. The method of claim 10, wherein the coating composition further comprises a cross-linking compound, and wherein curing the coating composition comprises initiating a cross-linking reaction between the cross-linking compound and the binder and/or nanomaterials.

18. The method of claim 10, wherein the coating has a thickness of less than 500 nm.

19. A substrate comprising a coating formed by the method of claim 10, wherein the coating imparts improved physical properties to the substrate.

20. The substrate of claim 19, wherein the coating improves at least one of the mechanical properties, the barrier properties, and the flame retardancy of the substrate.
